(19) United States
(12) Patent Application Publication
(10) Pub. No.: US 2005/0091194 A1
(43) Pub. Date: Apr. 28, 2005

(54) List acquisition method and system

(76) Inventors: Peter Anthony Jupp, Olivenhain, CA (US); Teresa Marie Dugan-Mansfield, Fallbrook, CA (US)

Correspondence Address: DUCKOR SPRADLING METZGER, 401 WEST A STREET, SUITE 2400, SAN DIEGO, CA, 92101-7915, US

(21) Appl. No.: 10/942,148

(22) Filed: Sep. 16, 2004

Related U.S. Application Data
(60) Provisional application No. 60/510,569, filed on Oct. 10, 2003.

(51) Int. Cl. G06F 17/30

(52) U.S. Cl. 707/2

(57) ABSTRACT

A method and system as disclosed relate to the sending of a prospective customer list to a list user, and receiving a suppression list based on the customer list from the list user. The suppression list causes another customer list to be restricted for the customer user to create a net customer list. The net customer list is sent to the list user.

### RELATED APPLICATION

This application claims priority to U.S. provisional patent application entitled LIST ACQUISITION METHOD AND SYSTEM, Application No. 60/510,569, filed Oct. 10, 2003.

### FIELD OF THE INVENTION

The present invention relates in general to a list acquisition method and system. It more particularly relates to such a new method and system for facilitating the acquisition of effective mailing lists.

### BACKGROUND ART

There is no admission that the background art disclosed in this section does legally constitute prior art.

Mailing lists are compiled by list owners, and marketed to list users for the purpose of mailing advertisements or promotional materials to prospective purchasers. The list user may pay for a list of names from the list owner pursuant to an agreement that the list may be used one time only, or other such arrangements.

The list user typically may rent lists from the list owner on a periodic basis such as monthly. When the new list is received from the list owner, the list user typically filters out unusable names such as duplicates, present customers and others by using a merge/purge process. The remaining names comprise the net list which may be used as a basis for paying the list owner for the right to use the list. This type of net name agreement or arrangement may require the list user to pay for a certain minimum number of names, even though a small number of names are actually useable. For example, if a list of one million names is provided, a negotiated rental price may be based on a minimum number such as 20% of the list, or 200,000 names. Even though less than 200,000 names prove to be useful, the list user must pay for 200,000 names. Thus, the list user tries to predict how many names will prove to be useable.

There are a number of areas in the list acquisition process that may not be functioning as effectively for a list user as they would like. For example, an excess amount of non-mailable items falling out of the merge/purge process with only occasional occurrences of nets or minimum numbers being exceeded. As an example, a net usable list of 25% is agreed to, but the net useable list results in only 20% being useable. There is also, in some circumstances, an increasing difficulty in predicting the net mailable quantity from the merge/purge process and such unpredictability complicates the planning process. Moreover, rental prices for some lists are less attractive to list users.

There are at least four key elements of list acquisition that affect the complexity, cost and final mailing quantity for any given campaign. These can be defined as follows: (1) price negotiations; (2) net name arrangements; and (3) omits

There are competing pressures of, on the one hand, increasing the net useable names, and on the other hand of reducing the price per move. In this regard, the list owner is constantly attempting to accomplish both higher nets, and lower prices per names, without sacrificing profits.

Price is determined not only by the negotiating skills of a list broker but also by the revenue and profit potential for any given list owner. A list user is currently coming fairly close, and in some rare cases exceeding, its net name floor. Not only does this pose a potential net cost for a list user, but it also increases the difficulty of negotiating sufficiently low nets from list owners, while simultaneously achieving low pricing.

There are two elements of primary omits that impact the conventional list acquisition arrangements. For example, the first is that a list user currently may request the previous month's order to be omitted from the subsequent month but not beyond that. The second is that a list user commonly does not want to mail to certain addresses such as post office box addresses rather than street addresses, as well as names with first name initials only. While this may seem like a simple omit for list owners, there are two problems. Firstly, some list owners are unable or unwilling to remove post office box addresses or first name initial records from their file. Secondly, in some cases the list managers or list owners do not, in fact, remove them. This is often due to the very short turn around time they are given to deliver the lists, and sometimes simply due to oversight.

During the conventional merge/purge process, a list user removes duplicates from its own customer file, National Change of Address (NCOA) files, do not mail files, and deceased files. This process often results in a net mailable file of 20%-25% of the total names ordered.

As list users respond to the pressures of public sensitivity to privacy issues and the need for better acquisition performance, they have been forced to increase the sophistication of their merge/purge process. This is driving net mailable names from the individual lists down. In turn, list users are increasing the pressure on their list brokers to negotiate better net name arrangements. As response rates to promotions and advertisements sent via mail continue to decline in some areas, there is increasing pressure on list brokers representing list owners to negotiate lower base prices. These factors have resulted in lower revenues per name for list owners, to the point where some list owners are finding it uneconomical to continue to rent their names to some large volume list users.

### BRIEF DESCRIPTION OF THE DRAWINGS

The features of this invention and the manner of attaining them will become apparent, and the invention itself will be best understood by reference to the following description of certain embodiments of the invention taken in conjunction with the accompanying drawings, wherein:

FIG. 1 is a block diagram of a list acquisition system according to a disclosed embodiment of the present invention;

FIGS. 2 and 3 illustrate a flow diagram for the system of FIG. 1; and

FIG. 4 is a flow chart illustrating the creation of a suppression file.

### DETAILED DESCRIPTION OF CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of the embodiments of the system, components and method of the present inventions, as represented in the drawings, is not intended to limit the scope of the invention, as claimed, but is merely representative of the embodiment of the invention.

A method and system as disclosed relate to the sending of a prospective customer list to a list user, and receiving a suppression list based on the customer list from the list user. The suppression list causes another customer list to be restricted for the customer user to create a net customer list. The net customer list is sent to the list user.

According to an embodiment of the invention, the suppression list is created as a result of one or more of the following: suppressing invalid addresses, suppressing intralist duplicates, suppressing NCOA files and Delivery Sequence File (DSF), suppressing interlist duplicates, suppressing list user drops, suppressing external verification files information, or other.

The disclosed embodiment of the invention may allow an opportunity to improve the revenue and profit potential for existing list owners, which in turn may afford an opportunity to reduce pricing.

It is believed that the present embodiment of the system and method of the present invention would allow a list user to accept significantly higher nets from list owners in some circumstances.

In some applications, by using the system and methods of the disclosed embodiments of the invention on existing files, the list owner could be offered increased revenue in exchange for lower prices. For some applications, this may represent advantages to both parties. For example, a list owner is typically going to make his or her decision about accepting net pricing and net names based on total revenue. A typical retail price for a list may, for example, be $90 per thousand names. As the following table shows the alternative to agreeing to the typical price and net arrangements for 1 million names for a list user is a mere 180,500 names from a different list user or mailer (assuming the industry-standard 80% net on this volume).

| Retail | | Net Price per | Net Name | Net Name | |
|---|---|---|---|---|---|
| Price | Volume | 1000 names | Percentage | Quantity | Revenue |
| $90 | 180,500 | $90 | 80% | 144,400 | $13,000 |
| $90 | 1 Million | $65 | 20% | 200,000 | $13,000 |

The first line of the foregoing table represents a typical list transaction. On this basis it is apparent why it is extremely difficult to better the current arrangements—and yet a list user is under extreme pressure to do so. However, an improved pricing and revenue structure may well be achievable through the use of the system and methods of the disclosed embodiments. Such may benefit both a list user and the list owner as indicated in the following table.

| | | Net Price per | | |
|---|---|---|---|---|
| Retail Price | Volume | 1000 names | Net Name | Revenue |
| $90 | 180,500 | $90 | 80% | $13,000 |
| $90 | 1 Million | $60 | 30% | $18,000 |
| $90 | 1 Million | $55 | 35% | $19,250 |
| $90 | 1 Million | $50 | 40% | $20,000 |
| $90 | 1 Million | $45 | 50% | $22,500 |
| $90 | 312,500 | $90 | 80% | $22,500 |

What becomes evident from this example is that the list owner can afford to reduce his/her or its price based on the net name arrangement and actually increase his/her or its net revenue. Their alternative volume of names to replace a list user rises substantially. Providing the list user can safely agree to a higher net name arrangement, they reduce their cost per name mailed substantially. There are two additional benefits that would accrue to a list user through the use of the system and methods of the disclosed embodiment. Firstly, reducing the number of names falling out of the merge/purge process may allow the list user to plan mailing volumes more accurately for certain applications. Secondly, reducing the number of names falling out of the merge/purge process may enable the list user to reduce its processing costs under some circumstances.

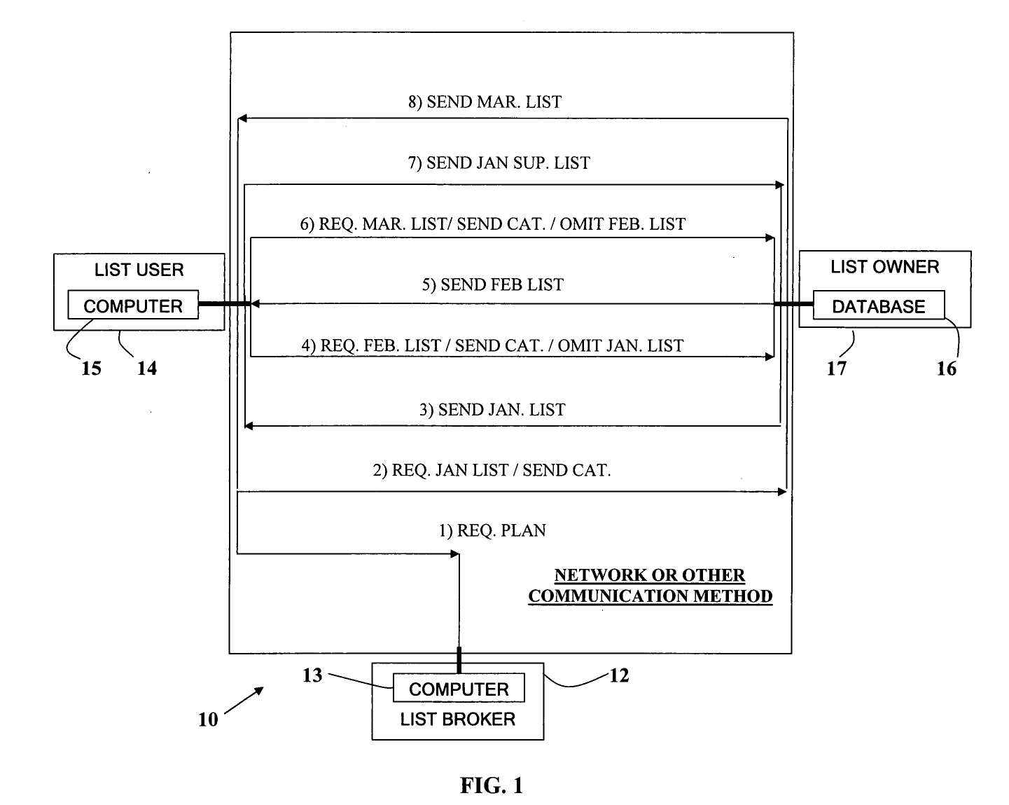

Referring now to the drawings and more particularly to FIG. 1 thereof, there is shown a list acquisition system 10, which is constructed according to certain embodiments of the invention. A list broker 12 establishes a list acquisition plan for a list user 14. In this regard, the list broker 12 determines that a particular mailing list is appropriate for the list user, or alternatively, the list user may already be using a mailing list owned by a list owner 17.

In general, the broker 12 having a computer 13 establishes the list acquisition plan. A list user or mailer 14, having a computer 15, has used the list and established a list suppression file by filtering out names which are not desired. The list user computer 15 communicates with a computer 16 of a list owner 17 at periodic intervals such as monthly. In this regard, the list user 14 sends a message via its computer 15 to the list owner 17, to request a certain new list of names fitting a certain criterion such as certain demographic categories. It should be understood that this list request message could alternatively be sent via a third party such as the list broker 12. The list user 14 also sends the suppression list to the list owner 17, or alternatively to a third party such as the broker 12. In general, a third party (not shown) such as a service bureau could provide the computer facilities for the list user, the list owner, or the list broker.

The list owner 17 then employs the suppression file to filter out certain names on the list to arrive at the new net list requested by the list user. This process is repeated monthly or at other desired intervals. In this manner, the suppression file is revised each time, and the new list being generated each time is increasingly effective.

This plan of the disclosed embodiments may function more efficiently and more effectively for some applications for files that the list user 14 is planning to mail more than twice. For example, after each merge/purge process, the list user 14 returns the file of suppressed names to the list owner 17. The list owner 17 could then be able to run this suppression before delivering the current month's names to the list user 14.

The list owner 17 runs a suppression prior to submitting the list to the list user—at his/her or its cost. The list owner 17 may do the suppression, or alternatively pay a Service Bureau to perform this operation. If it is assumed that $1.00 per 1,000 names is charged by the Service Bureau, then this operation may cost approximately $1,000, which added cost may not be sufficient to jeopardize the economics of the plan. The additional process may also take additional time, something which is not always available. However, the benefits are sufficient for the list user 14 to see if they can provide sufficient extra time for this step to be taken.

The return of a suppression file may be a sensitive issue for the list user 14. However, the list user 14 would not be returning any of its own files—simply a file of the list owner's names that were suppressed for multiple reasons from the merge/purge process. It may be impossible or at least highly unlikely for a list owner 17 to determine which of the names had been suppressed for which individual reason (which may include being an existing list user customer). For many applications, the plan may provide a significant benefit to the list user for the future for at least some applications.

Considering the system 10 in greater detail with reference to FIG. 1, in use, the computer 15 of the list user 14 initially sends a request for a list acquisition plan to the computer 13 of the list broker 12. Once the plan is established, assume that the computer 15 of the list user 14 sends a request for a customer list together with various desired categories to the database 16 of the list owner 17. This is an initial request for a list according to the list acquisition plan. In the present example, it is assumed that this initial request occurs in the month of January.

The list owner 17 randomly selects a list of prospective customer names from the database 16 and sends the January list to the computer 15 of the list user 14. The list user 14 then uses the computer 15 to run a merge/purge operation to filter out unusable names from the January list as hereinafter described in greater detail. As a result, the list user compiles a January suppression list and stores it in the computer 15. The list user then employs the list for mailing purposes based on the usable names on the net list, and pays the list owner for the one-time use of the January list.

During the month of February, the list user 14 utilizing its computer 15 sends a request for a February list, together with desired categories to the database 16 of the list owner 17. Assume that the request for the February list includes a request that the names from the January list be omitted from the February list. The list owner is able to accommodate such a request, since the list owner will have tagged all of the names on the January list so that they will not be included in the February list.

The list owner 17 then compiles a February list with the January names omitted and sends it to the computer 15 of the list user 14.

During the following month of March, a request is sent from the list user computer 15 for a current March list, together with certain categories and a request that the February list names be omitted. This request is received by the list owner 17. The January suppression list created by the list user 14 is sent from the computer 15 to the database 16 of the list owner 17. This suppression list may be sent at any time to the list owner 17, and is used by the list owner 17 to prevent such names from being included in the current March list. The tagged February names are also omitted during the compilation of the March list. Once the March list is compiled, it is sent from the database 16 to the list user computer 15. Such a list should have a large number of useful names since many unuseful names were already determined during the merge/purge operation performed in January.

This operation of the system 10 may be repeated indefinitely. For example, during the next month, an April list can be requested by the list user 14 together with requested categories and a request to omit March list names. The list user 14 may also send both a January suppression list and a February suppression list, or a combination of the two, to the list owner so that both the January and the February suppression lists may be used in the compiling of the April list. The dynamically expanding suppression materials may be compiled by the list owner, the list user, the list broker or others. In this manner, the suppression list or lists will continue to grow in size, and thus become progressively more rich in nature to help produce a current monthly list having a progressively higher percentage of actual net usable names.

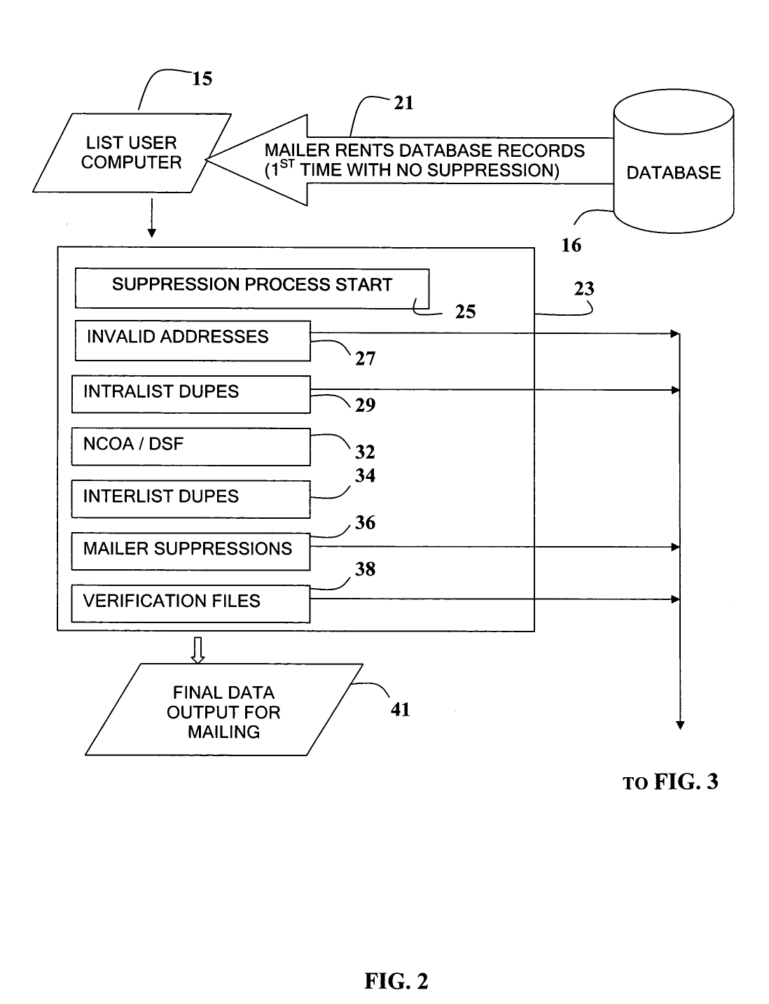

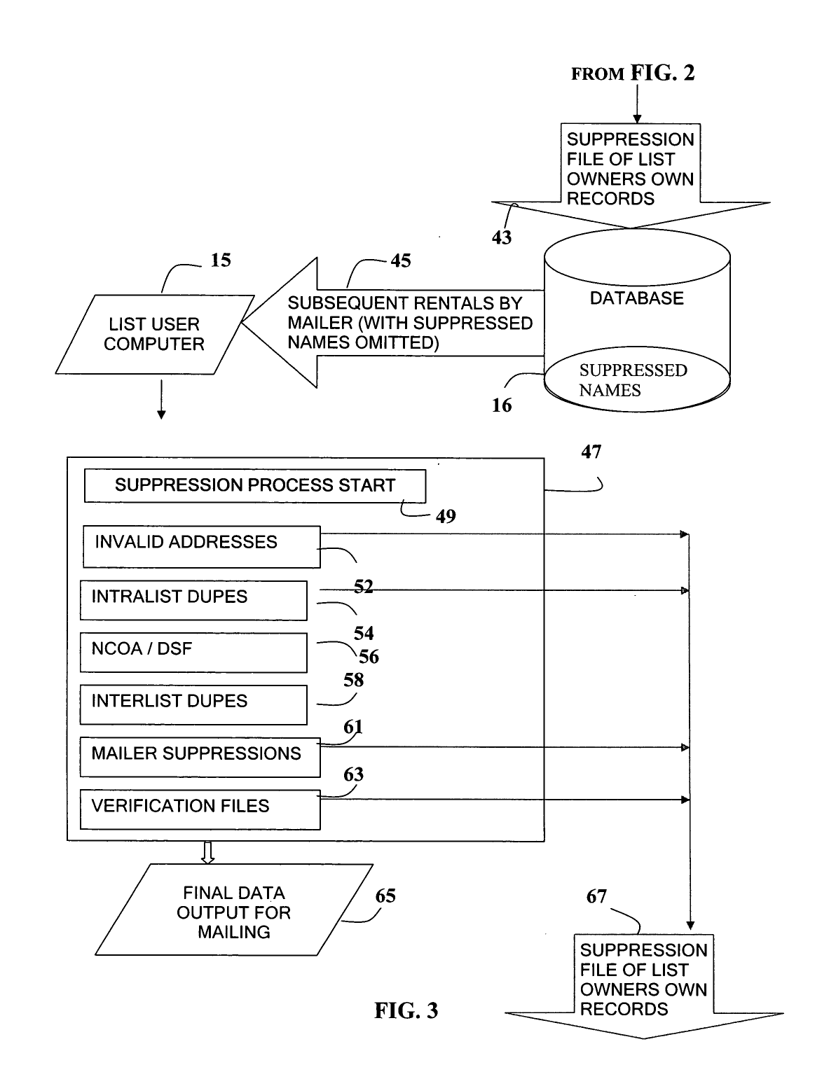

Considering now the system 10 in still greater detail, with reference to FIGS. 2 and 3 of the drawings, as indicated at 21, the list user or mailer rents the database records from the list owner and an initial list is then compiled and sent to the list user computer 15. This initial list is not suppressed.

Once the initial list is received in the list user computer 15, a suppression list is created as indicated at 23 by means of software modules in the list user computer 15 or other location such as at a service bureau or the list broker 12. The suppression process starts at 25, and includes suppressing invalid addresses as indicated at 27. Also, intralist duplicates are suppressed at 29. As indicated at 32, NCOA/DSF information is also suppressed from the initial list. Interlist duplicates are suppressed at 34, and mailer suppressions are suppressed at 36. Verification files are suppressed as indicated at 38.

As a result of the suppression process, a final data output list for mailing is created as indicated at 41. Additionally, the suppression list is then supplied to the list owner database 16 as indicated at 43 (FIG. 3) or other location where the suppress list may be used.

During subsequent rentals of mailing lists as indicated at 45, the database 16 of the list owner 17 is employed to suppress the names on the previously received suppression list to create a current new list which is supplied to the list user computer 15. The new list is then subjected to another suppression process as indicated at 47. The next suppression process is started at 49 and includes suppressing invalid addresses at 52 and intralist duplicates at 54. Also, as indicated at 56, NCOA/DSF information is suppressed. As indicated at 58, interlist duplicates are suppressed, and mailer suppressions occur at 61. Verification files are suppressed as indicated at 63. The resulting final data output occurs as indicated at 65 for mailing by the list user. This suppression list is then supplied to the list owner for storage in the database 16 for suppressing new lists for the list user 14 as indicated at 67.

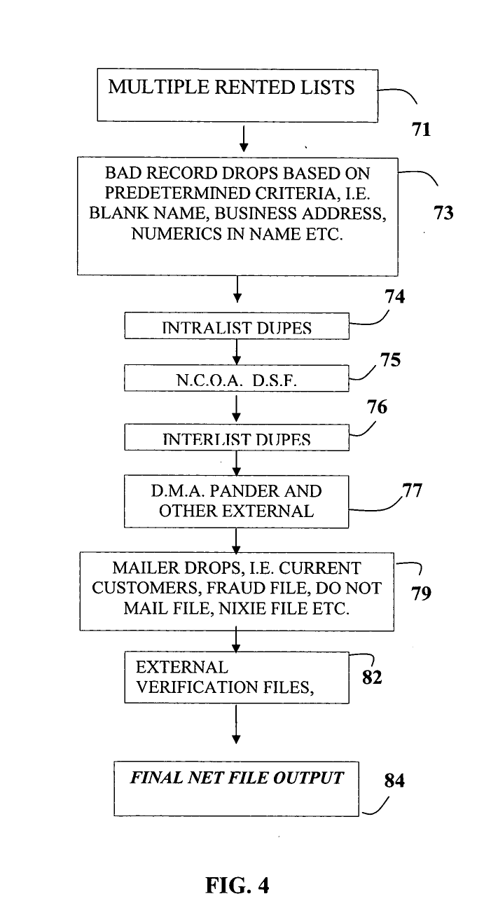

Considering now the suppression process in greater detail with reference to FIG. 4, the suppression process starts with a rented list as indicated at 71. Invalid addresses are suppressed as indicated at 73, and include suppressing bad record drops based on predetermined criteria. This criteria may include, for example, blank names, business addresses, numerics in the name of the person, and other such incorrect or invalid information.

As indicated at box 74, intralist duplicates are suppressed. As indicated at box 75, the National Change of Address (N.C.O.A.) of the postal service file is used for suppressing unwanted or unuseful names from the list. Also, the Delivery Sequence File (DSF) is also used to suppress unwanted names, as this list is also provided by the postal service to validate addresses.

As indicated in box 76, interlist duplicates are suppressed. This information is compiled and known by the list user 14. The list user 14 may be using several different lists from different list owners (not shown), and the list user 14 can compile a list of the same name appearing on different lists.

In box 77, a Direct Marketing Association (DMA) pander file is used for suppression purposes. The pander file is a list of people who have contacted the DMA and asked to be removed from all mailing lists. Other such external files may also be used to suppress the list.

As indicated at box 79, the list user 14 drops are suppressed. In this regard, for example, current customers, fraud files, do not mail files, nixie files, and others are suppressed from the rented list.

As indicated at box 82, external verification files are used to further suppress the rented list. Such files may be obtained from third parties such as the one known as Acxiom Infobase. The resulting suppressed net file is produced at box 84. For example, assuming a rented list of 20,000,000 names, the remaining usable names may be only 6,200,000 so that there is only a 31% net usable list. The remaining 13,800,000 names (69%) of the list comprise a suppression file.

The following is an example of a suppression analysis assuming a rented list containing 20,000,000 names:

| | | |
|---|---|---|
| Total Input Names | 20,000,000 | 100% |
| Invalid addresses | 2,000,000 | 10% |
| Remaining Names | 18,000,000 | 90% |
| Intralist dupes | 100,000 | 0.056% |
| NCOA/DSF | 600,000 | 0.3% |
| Interlist dupes | 3,600,000 | 20% |
| Remaining Names | 13,700,000 | 68.50% |
| Issuer suppressions | 3,500,000 | 25% |
| Remaining Names | 10,200,000 | 51% |
| Verification files | 4,000,000 | 39% |
| Remaining Names | 6,200,000 | 31% |

In this example, the issuer suppressions include existing customers, credit declines, fraud files, and others.

The pressures of public sensitivity to privacy issues and the need for better acquisition performance, has forced list users to increase the sophistication of their merge/purge process. This is driving net mailable names from individual lists down in many instances.

The embodiment of the system 10 as disclosed herein may shift part of the suppression process to the list owner. Every month, the list owner is provided with a file containing all the suppressions from the merge/purge process specific to their list. This suppression file is run against the list owners file when producing the next order for the list user. This substantially reduces the drops in the merge/purge process allowing the list user to accept a higher net name arrangement and the list owner to accept a lower base list price.

By creating a single suppression file specific to each list, the list user returns only the names from each individual list owner's own file. In this way the list user helps maintain the confidentiality of its customers and other internal suppression files.

To illustrate the potential savings in certain circumstances when using the system 10 as disclosed herein, the following example is based on the following assumptions:

1) 10 million gross names per month;

2) 70% roll-outs (lists mailed regularly) of which 50% agree or are able to participate in this system;

3) 25% inter-list dupes; and

4) $5.00 run charge per thousand names.

The total savings may be as follows:

| | | | | | TOTAL |
|---|---|---|---|---|---|
| | CURRENT | OPTIONAL | LIST | RUN CHARGE | MONTHLY |
| QUANTITY | PRICE & NET | PRICE & NET | SAVINGS | SAVINGS | SAVINGS |
| 1 Million | $65/20% | $50/40% | $15 × 3.5 MM = | 20% × 3.5 MM | $56,000 |
| | | | $52,000 | *$5 = | |
| | | | | $3,500 | |
| | | 45/50% | $20 × 3.5 MM = | 30% × 3.5 MM | $72,250 |
| | | | $70,000 | *$5 = | |
| | | | | $5,200 | |
| | | 40/60% | $25 × 3.5 MM = | 30% × 3.5 MM | $94,500 |
| | | | $87,500 | *$5 = | |
| | | | | $7,000 | |

Assuming the list user chooses to adopt the $50.00 price with the 40% net name arrangement, their annual savings would amount to over $650,000. Coupled with the reduced costs of their own merge/purge process savings in this example would exceed $750,000 per year.

The system 10 improves the revenue and profit potential for the list owner 17 thus allowing it to reduce the base price of their list.

Historically, and understandably, large volume list users have usually not been willing to release any of their proprietary information to outside parties. However, by creating a single suppression file for each list owner, the large volume list users are only returning to the list owner those names from the list owner's own file. In this way the large volume list users maintains the confidentiality of its customers and other internal suppression files.

When negotiating prices and nets, a list owner is going to look at alternatives. A typical retail price for a list is, for example, $90 per thousand names. The following table shows a list owner may make the same revenue from another mailer ordering 180,500 names (assuming the industry-standard 80% net on this volume) as he/she or it does with the typical negotiated price and net arrangements for 1 million names for a typical large volume mailer.

| Type of | Retail | | Negotiated | Net Name | Revenue to |
|---|---|---|---|---|---|
| Customer | Price | Volume | Price | Agreement | List Owner |
| Small | $90 | 180,500 | $90 | 80% | $13,000 |
| volume | | | | | |
| mailer | | | | | |
| Large | $90 | 1 million | $65 | 20% | $13,000 |
| volume | | | | | |
| mailer | | | | | |

Using the disclosed embodiments of the system 10, the list user may be able to accept a higher net in return for a lower price, depending on the circumstances. As can be seen from the “Revenue to List Owner” column in the following table, as the price declines and the net rises, the revenue to the list owner increases. At a 60% net and a price to the large volume user of only $40 per thousand, the list owner obtains a revenue of $24,000. Whereas, for a small volume list user, the list owner would have to rent twice as many names (355,500) (assuming a 75% net) in order to match the revenue from the large volume list user.

| Type of | Retail | | Negotiated | Net Name | Revenue to |
|---|---|---|---|---|---|
| Customer | Price | Volume | Price | Agreement | List Owner |
| Large | $90 | 1 million | $65 | 20% | $13,000 |
| volume | | | $60 | 30% | $18,000 |
| list user | | | $55 | 35% | $19,250 |
| | | | $50 | 40% | $20,000 |
| | | | $45 | 50% | $22,500 |
| | | | $40 | 60% | $24,000 |
| Small | $90 | 355,500 | $90 | 75% | $24,000 |
| volume | | | | | |
| list user | | | | | |

The savings from using the disclosed embodiment of the system 10 may vary depending on: the maturity of the program (in the early stages, the effect of the suppression program may be limited); and the universe of the file. The list owner is only likely to accept a higher net for a lower price if there are sufficient names on file to be able to guarantee the higher income for the list owner on an ongoing basis.

Also, the following are factors affecting the amount of savings: the number of names being mailed, specifically from lists that are being reused; the rate of drops from suppressions rather than duplicates; and the level of “exchange” of price vs. net name discount.

When using the disclosed embodiment of the system 10, under certain circumstances, the benefits to the list user may be realized and are shown in the following table based on the following assumptions:

1) 10 million gross names per month;

2) 70% roll-outs (lists mailed regularly) of which 50% agree or are able to participate in this system;

3) 25% inter-list duplicates; and

4) $5.00 per thousand run charges.

| | | OP- | | | |
|---|---|---|---|---|---|
| | CURRENT | TIONAL | | RUN | TOTAL |
| QUAN- | PRICE & | PRICE & | LIST | CHARGE | MONTHLY |
| TITY | NET | NET | SAVINGS | SAVINGS | SAVINGS |
| 1 | $65/20% | $50/40% | $15 × 3.5 | 20% × 3.5 | $56,000 |
| Million | | | MM = | MM *$5 = | |
| | | | $52,000 | $3,500 | |
| | | 45/50% | $20 × 3.5 | 30% × 3.5 | $72,250 |
| | | | MM = | MM *$5 = | |
| | | | $70,000 | $5,200 | |
| | | 40/60% | $25 × 3.5 | 40% × 3.5 | $94,500 |
| | | | MM = | MM *$5 = | |
| | | | $87,500 | $7,000 | |

Assuming the list user chooses to adopt the $50.00 price with the 40% net name arrangement, under certain circumstances, their annual savings may amount to over $650,000 per year. Also, the list user may be able to reduce the costs of their own merge/purge process.

While the return of a suppression file to the list owner may be a sensitive issue for the list user under some circumstances, the list user would not be returning any of their own files—simply a file of the list owner's names that were suppressed for multiple reasons from the merge/purge process. It may be impossible, or at least extremely difficult, for a list owner (even if they had the desire to do this, which seems highly unlikely) to determine which of the names had been suppressed for what reason.

While particular embodiments of the present invention have been disclosed, it is to be understood that various different modifications are possible and are contemplated within the true spirit and scope of the appended claims. There is no intention, therefore, of limitations to the exact abstract or disclosure herein presented.

1. A list acquisition method, comprising:
sending a prospective customer list to a list user;
receiving a suppression list based on the customer list from the list user;
causing the suppression list to be used to restrict another customer list for the customer user to create a net customer list; and
sending the net customer list to the list user.

2. A method according to claim 1, further including repeating the causing the suppression list to be used.

3. A method according to claim 1, wherein the causing the suppression list to be used includes one selected from the group consisting of suppressing invalid addresses, suppressing intralist duplicates, suppressing NCOA/DSF, suppressing interlist duplicates, suppressing list user drops, and suppressing external verification files information.

4. A method according to claim 1, further including receiving an initial request from the list user for the prospective customer list, and wherein the sending a prospective customer list is the sending of an initial unsuppressed list.

5. A method according to claim 4, further including receiving a request from the list user for said another customer list.

6. A method according to claim 5, further including receiving a request for a further customer list after the initial unsuppressed list is sent.

7. A method according to claim 6, further including sending a further customer unsuppressed list to the list user.

8. A method according to claim 7, wherein the causing the suppression list to be used includes suppressing invalid addresses, suppressing intralist duplicates, suppressing NCOA/DSF, suppressing interlist duplicates, suppressing list user drops, and suppressing external verification files information.

9. A list acquisition software system, comprising:
a module for sending a prospective customer list to a list user;
a module for receiving a suppression list based on the customer list from the list user;
a module for causing the suppression list to be used to restrict another customer list for the customer user to create a net customer list; and
a module for sending the net customer list to the list user.

10. A method according to claim 9, further including repeating the causing the suppression list to be used.

11. A method according to claim 9, wherein the module for causing the suppression list to be used includes one selected from the group consisting of a module for suppressing invalid addresses, a module for suppressing intralist duplicates, a module for suppressing NCOA/DSF, a module for suppressing interlist duplicates, a module for suppressing list user drops, and a module for suppressing external verification files information.

12. A method according to claim 9, further including a module for receiving an initial request from the list user for the prospective customer list, and wherein the sending a prospective customer list is the sending of an initial unsuppressed list.

13. A method according to claim 12, further including a module for receiving a request from the list user for said another customer list.

14. A method according to claim 13, further including a module for receiving a request for a further customer list after the initial unsuppressed list is sent.

15. A method according to claim 14, further including a module for sending a further customer unsuppressed list to the list user.

16. A method according to claim 15, wherein the module for causing the suppression list to be used includes a module for suppressing invalid addresses, a module for suppressing intralist duplicates, a module for suppressing NCOA/DSF, a module for suppressing interlist duplicates, a module for suppressing list user drops, and a module for suppressing external verification files information.

17. A list acquisition system, comprising:
means for sending a prospective customer list to a list user;
means for receiving a suppression list based on the customer list from the list user;
means for causing the suppression list to be used to restrict another customer list for the customer user to create a net customer list; and
means for sending the net customer list to the list user.

18. A system according to claim 17, further including means for repeating the causing the suppression list to be used.

19. A system according to claim 17, wherein the means for causing the suppression list to be used includes one selected from the group consisting of means for suppressing invalid addresses, means for suppressing intralist duplicates, means for suppressing NCOA/DSF, means for suppressing interlist duplicates, means for suppressing list user drops, and means for suppressing external verification files information.

20. A system according to claim 17, further including means for receiving an initial request from the list user for the prospective customer list, and wherein the sending a prospective customer list is the sending of an initial unsuppressed list.

21. A system according to claim 20, further including means for receiving a request from the list user for said another customer list.

22. A system according to claim 21, further including means for receiving a request for a further customer list after the initial unsuppressed list is sent.

23. A system according to claim 22, further including means for sending a further customer unsuppressed list to the list user.

24. A system according to claim 23, wherein the means for causing the suppression list to be used includes means for suppressing invalid addresses, means for suppressing intralist duplicates, means for suppressing NCOA/DSF, means for suppressing interlist duplicates, means for suppressing list user drops, and means for suppressing external verification files information.
